(19) United States
(12) Patent Application Publication
(10) Pub. No.: US 2023/0043780 A1
(43) Pub. Date: Feb. 9, 2023

(54) MOVEMENT-BASED ADJUSTMENT OF AN ELEMENT OF A USER INTERFACE

(71) Applicant: Capital One Services, LLC, McLean, VA (US)

(72) Inventors: Jeremy GOODSITT, Champaign, IL (US); Austin WALTERS, Savoy, IL (US); Galen RAFFERTY, Mahomet, IL (US)

(21) Appl. No.: 17/444,496

(22) Filed: Aug. 5, 2021

(51) Int. Cl. G06F 3/0484; G06F 3/01

(52) U.S. Cl. CPC G06F 3/04845; G06F 3/017

(57) ABSTRACT

In some implementations, a device may obtain data relating to movement of the device. The device may determine one or more adjustments to one or more elements of a user interface to be provided for presentation by the device. The one or more adjustments may be determined based on the data relating to the movement of the device. The device may cause presentation of the user interface with the one or more elements adjusted in accordance with the one or more adjustments.

### BACKGROUND

A display of a user device may display a user interface (e.g., a graphical user interface). The user interface may include a body with multiple user interface elements arranged to provide information to a user of the user device. The user interface may permit interactions between the user and the user device. In some cases, the user may interact with the user interface to operate and/or control the user device to produce a desired result. For example, the user may interact with the user interface to cause the user device to perform an action. Additionally, the user interface may provide information to the user.

### SUMMARY

In some implementations, a system for adjustment of a user interface to be provided for presentation by a device includes one or more memories, and one or more processors, communicatively coupled to the one or more memories, configured to: obtain data relating to movement of the device; determine, based on the data relating to the movement of the device, an activity being performed by a user of the device; select, from a data structure, one or more element adjustments for one or more elements of the user interface to be provided for presentation by the device, wherein the one or more element adjustments are selected based on the activity being performed by the user; insert code into a document for the user interface to cause adjustment of the one or more elements according to the one or more element adjustments; and provide the user interface for presentation by the device based on inserting the code into the document for the user interface.

In some implementations, a method of adjustment of a user interface to be provided for presentation by a device includes obtaining, by the device, using one or more sensors, data relating to movement of the device; determining, by the device, one or more adjustments to one or more elements of the user interface to be provided for presentation by the device, wherein the one or more adjustments are determined based on the data relating to the movement of the device; and causing, by the device, presentation of the user interface with the one or more elements adjusted in accordance with the one or more adjustments.

In some implementations, a non-transitory computer-readable medium storing a set of instructions for adjustment of a user interface to be provided for presentation by a device includes one or more instructions that, when executed by one or more processors of the device, cause the device to: receive a request to provide the user interface for presentation by the device; obtain, using one or more sensors, data relating to movement of the device; determine, using a data structure, one or more adjustments to one or more elements of the user interface to be provided for presentation by the device, wherein the one or more adjustments are determined based on the data relating to the movement of the device; insert code into a document for the user interface to cause adjustment of the one or more elements in accordance with the one or more adjustments; and provide the user interface for presentation by the device based on inserting the code into the document for the user interface.

### BRIEF DESCRIPTION OF THE DRAWINGS

FIGS. 1A-1D are diagrams of an example implementation relating to movement-based adjustment of an element of a user interface.

FIG. 2 is a diagram illustrating an example of training and using a machine learning model in connection with movement-based adjustment of an element of a user interface.

FIG. 3 is a diagram of an example environment in which systems and/or methods described herein may be implemented.

FIG. 4 is a diagram of example components of one or more devices of FIG. 3.

FIG. 5 is a flowchart of an example process relating to movement-based adjustment of an element of a user interface.

### DETAILED DESCRIPTION

The following detailed description of example implementations refers to the accompanying drawings. The same reference numbers in different drawings may identify the same or similar elements.

As described above, a user device may display a user interface, and the user interface may include one or more user interface elements that are arranged and sized according to a particular configuration. A user of the user device may be engaged in different activities at various times while using the user device. For example, the user may be walking while using the user device, the user may be running while using the user device, the user may be cooking while using the user device, etc. Based on the activity being performed by the user, a particular arrangement and/or sizing of user interface elements may be desirable, for example, to improve readability, user input, or the like. For example, an arrangement and/or sizing of user interface elements may be suitable when the user is walking, but unsuitable when the user is running. However, determining the activity that is being performed by the user is technically difficult and error prone.

Moreover, if the arrangement and/or sizing of user interface elements is unsuitable for the activity being performed by the user, the user may inadvertently select elements of the user interface, inadvertently provide commands through the user interface, input information with typographical errors, fail to notice and follow instructions provided in the user interface, or the like. As a result, excessive computing resources and/or network resources may be consumed in connection with the transmission and processing of requests made through the user interface that are inadvertent or incorrect.

A solution to the above technical problems is described herein for dynamically adjusting elements of a user interface displayed at a device based on data relating to movement of the device. In some implementations, the device may obtain (e.g., from one or more sensors of the device) data relating to movement of the device, and determine one or more adjustments to the user interface based on the data relating to the movement of the device. The device may determine the adjustments to the user interface directly from the data, or the device may use the data to determine an activity being performed by the user, which in turn can be used to determine the adjustments. The device may determine the one or more adjustments using a model and/or using a data structure that identifies element adjustments for user interface elements for various activities. In this way, the user interface may be adjusted to accommodate an activity in which a user is engaged. This improves the usability of the user interface, thereby reducing inadvertent or incorrect requests made through the user interface, and conserving computing resources and/or network resources.

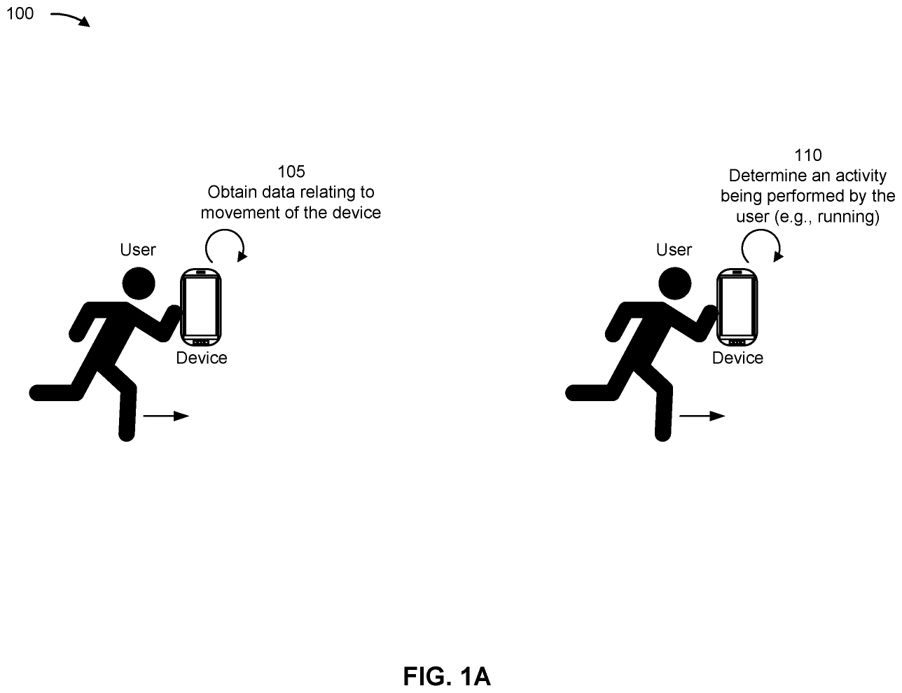

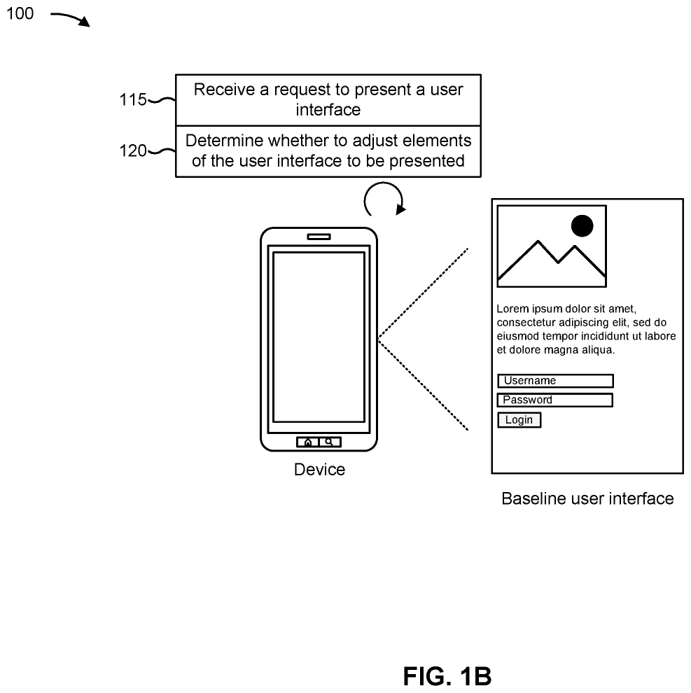

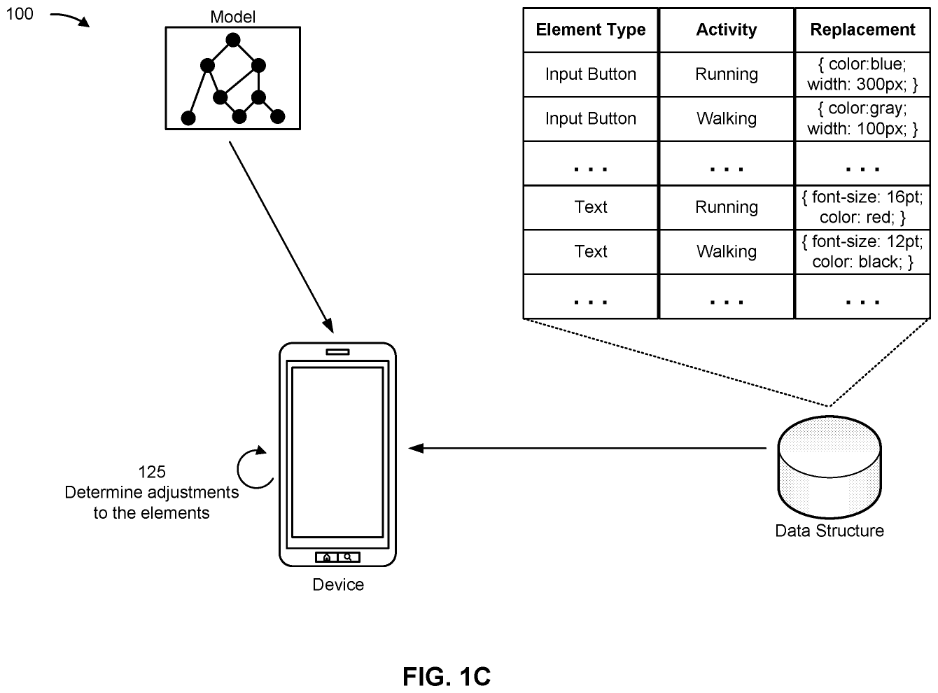

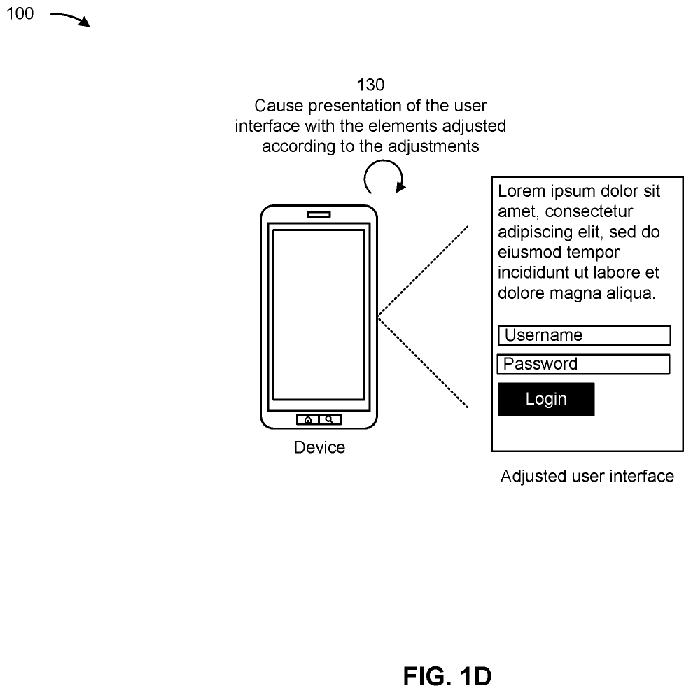

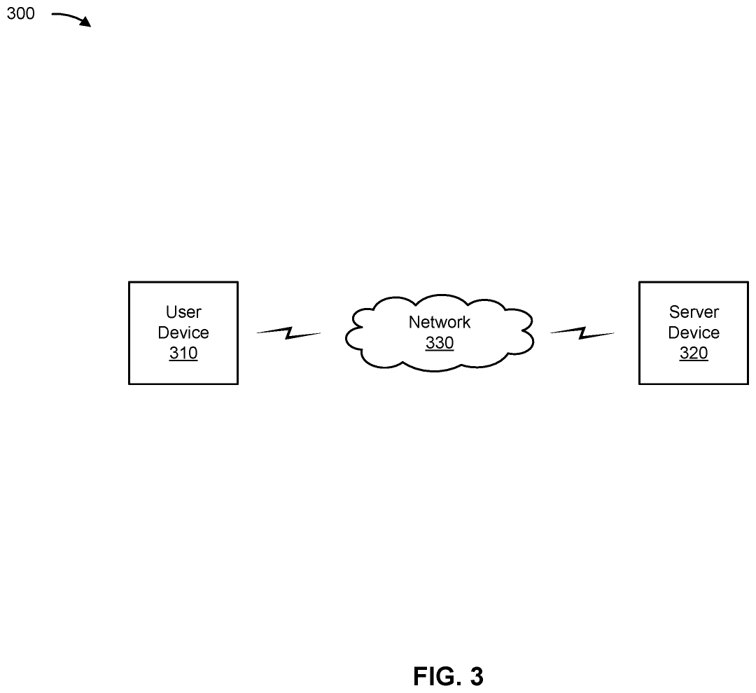

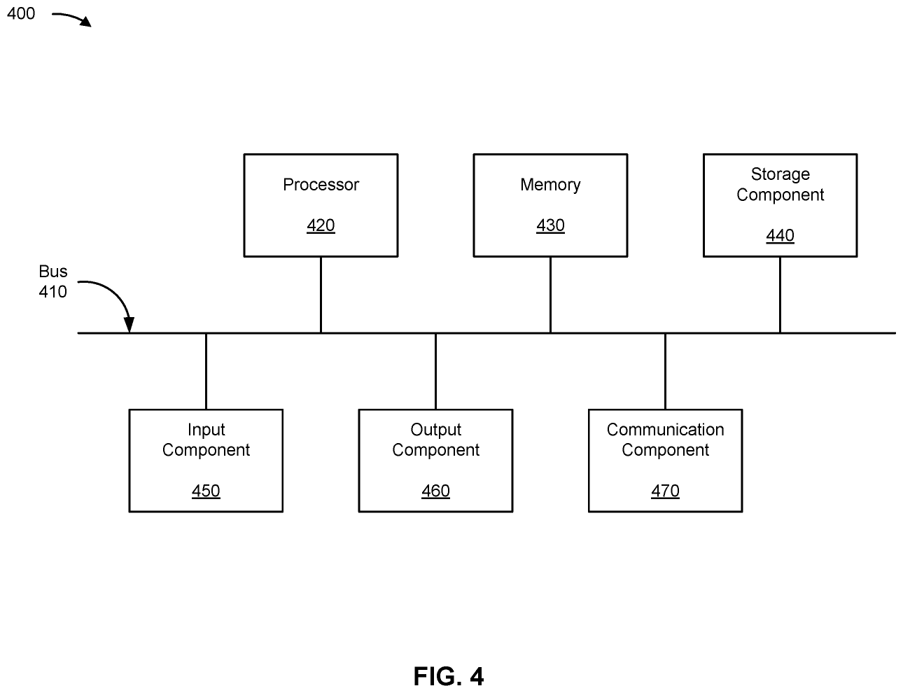

FIGS. 1A-1D are diagrams of an example 100 relating to movement-based adjustment of an element of a user interface. As shown in FIGS. 1A-1D, example 100 includes a device, which may be associated with a user (e.g., a user device). This device is described in more detail in connection with FIGS. 3 and 4. In some implementations, one or more operations described below may be implemented at an operating system of the device, thereby facilitating user interface element adjustment for any application implemented by the device.

As shown in FIG. 1A, and by reference number 105, the device may obtain data relating to movement of the device. For example, the device may obtain the data using one or more sensors of the device, such as an accelerometer, a gyroscope, a magnetometer, a global navigation satellite system (GNSS) (e.g., a global positioning system (GPS)), or the like. The data may include time series data that indicates movement of the device at various timepoints. The data may indicate (e.g., for each timepoint) a linear speed of the device, a rotational speed of the device, an acceleration of the device, a tilt of the device, a direction of movement of the device, or the like. In some implementations, the data (e.g., GPS data) may indicate a location of the device. The movement of the device may be due to an activity being performed by the user of the device. For example, if the user is engaged in a first activity (e.g., running), the movement data may be first movement data, and if the user is engaged in a second activity (e.g., dancing), the movement data may be second movement data that is different from the first movement data.

As shown by reference number 110, the device may determine an activity being performed by the user of the device. The activity may be a physical activity (e.g., an activity that relates to a movement and/or a position of the user). For example, the activity may be sitting, walking, running, biking, riding in a vehicle, cooking, dancing, or the like. The device may determine the activity based on the data relating to the movement of the device. For example, the data may indicate a particular type of movement (e.g., linear movement, rotational movement, movement associated with vibration, or the like) and/or a particular pattern of movement (e.g., a frequency of the movement, a consistency in the movement, or the like) that is indicative of the activity being performed by the user.

In some implementations, the device may determine the activity based on the movement data and additional information. The additional information may include calendar data for a calendar implemented by the device (e.g., the calendar may include an entry indicating the activity being performed, for example, “basketball game at 6 pm today”), location data for the device (e.g., indicating that the device is located at a location associated with a particular activity, such as a golf course, a dance studio, or the like), audio data associated with audio capture in an environment of the device (e.g., indicating sounds associated with a particular activity, such as a sound associated with tap dancing or biking), image data associated with image capture in an environment of the device (e.g., indicating images associated with a particular activity, such as an image of a storefront or a tennis court), biometric data of the user obtained by the device (e.g., heart rate data), or the like.

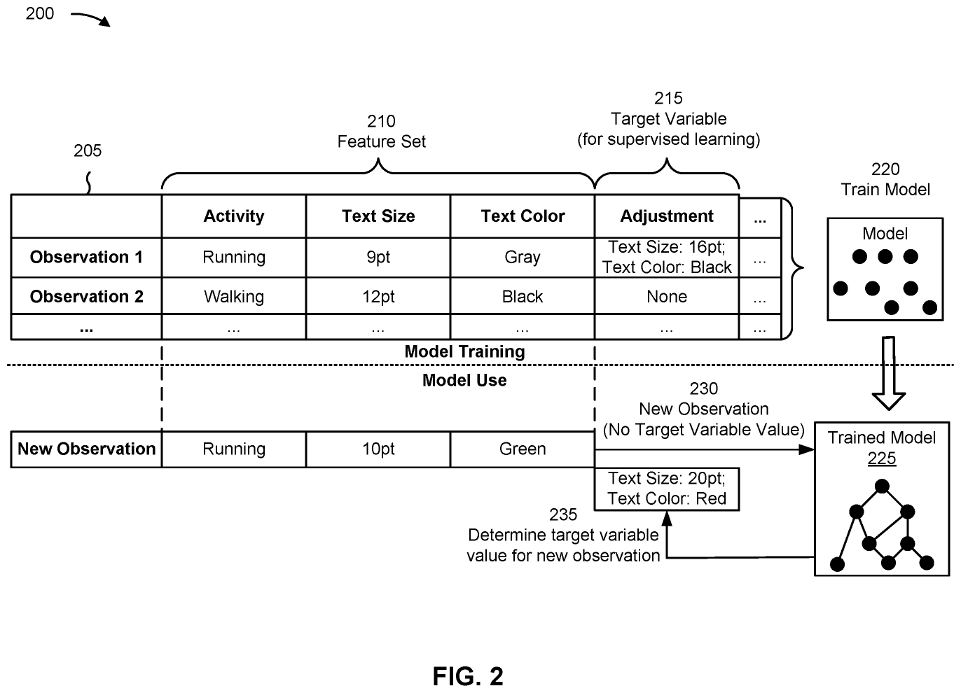

In some implementations, the device may determine the activity using a model (e.g., a machine learning model), in a manner as described in connection with FIG. 2. For example, the model may be trained, or otherwise configured, to output a determination of the activity based on an input of the data relating to the movement of the device and/or the additional information. In some implementations, the device may transmit the data and/or the additional information to another device (e.g., a remote server) that implements the model, and the device may receive an indication of the activity from the other device (e.g., based on a determination at the other device of the activity).

As shown in FIG. 1B, and by reference number 115, the device may receive (e.g., from an application executing on the device) a request to present a user interface. The user interface that would be presented, absent any adjustments to the user interface, may be referred to as the “baseline user interface.” The device may receive the request based on a user input to the device (e.g., a press of a button, a touch gesture on a touchscreen, or the like). For example, the request to present the user interface may include a request to access a web page, a request to launch an application, a request to access a particular feature of an application, a request to access a menu, or the like. In some implementations, the device may determine the activity being performed by the user based on receiving the request to present the user interface.

As described above, the baseline user interface may include one or more user interface elements. Based on receiving the request to present the user interface, the device may obtain (e.g., receive, load, or execute) code (e.g., hypertext markup language (HTML) code) that identifies one or more elements of the baseline user interface. The elements of the baseline user interface may include one or more textual elements, one or more form elements (e.g., a text input, a selection dropdown input, a checkbox input, or the like), and/or one or more user input elements (e.g., an input button, a hyperlink, or the like), among other examples.

In some implementations, the device may process the baseline user interface to obtain information relating to the elements of the baseline user interface. For example, the device may process (e.g., parse) the code for the baseline user interface. The information obtained by processing the baseline user interface may include information that identifies a type of an element (e.g., a form input element type, a text block element type, an input button element type, or the like), information that identifies one or more attributes of an element (e.g., a size, a text size, a text color, a background color, a shape, or the like), information that identifies a position or relative position of an element in the user interface, information that identifies a level of importance of an element (e.g., boilerplate text in a footer of the user interface may be assigned a low importance, while a form of the user interface may be assigned a high importance), or the like.

As shown by reference number 120, the device may determine whether to adjust one or more elements of the baseline user interface. In some implementations, the device may determine whether to adjust the elements based on the activity that is determined. For example, the device may determine to adjust the elements if the activity is a particular activity, such as a non-stationary activity (e.g., running, biking, dancing, or the like). In some implementations, the device may determine whether to adjust the elements based on the data relating to the movement of the device. For example, the device may determine to adjust the elements if the movement data is indicative of a threshold amount of movement. Thus, in some examples, the device may determine whether to adjust the elements based directly on the movement data, and accordingly, the device may refrain from determining the activity being performed by the user in such examples. In some implementations, the device may determine to adjust the elements based on a determination that element adjustment is enabled for the device (e.g., according to a user setting).

As shown in FIG. 1C, and by reference number 125, the device may determine one or more adjustments to the elements of the baseline user interface. For example, the device may determine the adjustments to the baseline user interface based on determining to adjust the baseline user interface. The device may determine the adjustments based on the data relating to the movement of the device and/or based on the activity that is determined. An adjustment may be to at least one of a size (e.g., a font size or an element size), a shape, a color (e.g., a text color or a background color), a location (e.g., an element occupying the left half of the baseline user interface may be adjusted to span the entire width of the user interface), a formatting (e.g., underlining, line spacing, list formatting, or the like), a type (e.g., from one form input type to another form input type), an interactable area (e.g., a size of an area of the user interface on or around an element for selection or activation of the element in response to a user interaction, such as a tap, may be increased without increasing a size of the element), or a behavior (e.g., an element that is activated by a single tap in the baseline user interface may be adjusted to be activated by a double tap) of one or more elements of the baseline user interface.

In some implementations, the device may determine the adjustments using a data structure (e.g., a database). The data structure may be implemented by the device or another device (e.g., a remote server) communicatively connected to the device. The data structure may store information relating to a plurality of element adjustments for elements of a user interface. For each element adjustment, the information may identify a type of element that the element adjustment adjusts (e.g., a text input element, an input button, a text paragraph, among other examples), attributes of an element that the element adjustment adjusts, screen attributes for which the element adjustment is used (e.g., a screen size, a screen resolution, or the like), an activity for which the element adjustment is used (e.g., running, dancing, or the like), and/or a movement signature (e.g., based on movement data, as described above) for which the element adjustment is used. An element adjustment may include replacement information for an element of a user interface and/or for attributes (e.g., text size, text color, or the like) of an element of the user interface. For example, an element adjustment may include replacement code (e.g., replacement cascading style sheet (CSS) code, replacement HTML, code, replacement JavaScript code) for the element.

Thus, to determine the adjustments, the device may select one or more element adjustments, for one or more elements of the baseline user interface, from the data structure. The device may select the element adjustments based on the data relating to the movement of the device. For example, the device may select the element adjustments based on the activity that is determined (e.g., select element adjustments that have an association, in the data structure, with the activity). As an example, the device may select one or more first element adjustments if the activity being performed by the user is a first activity, and the device may select one or more second element adjustments if the activity being performed by the user is a second activity. Additionally, the device may select the element adjustments based on the type of elements of the baseline user interface, attributes of the elements of the baseline user interface, screen attributes of the device, or the like.

In some implementations, the element adjustments may be based on historical data relating to interactions with adjusted elements by one or more other users performing the activity and/or one or more other users associated with movement data similar to the user's movement data (e.g., a calculated similarity between the movement data of another user and the movement data of the user satisfies a threshold value). For example, the element adjustments may be based on an optimization technique (e.g., AB testing). As an example, according to the optimization technique, a first element adjustment may be used for a first group of users determined to be performing a particular activity and/or that are associated with similar movement data, and a second element adjustment may be used for a second group of users determined to be performing the activity and/or that are associated with the similar movement data. Continuing with the example, interactions of the first group of users with the user interface modified according to the first element adjustment may be monitored, and interactions of the second group of users with the user interface modified according to the second element adjustment may be monitored. Based on monitoring the interactions, an optimal element adjustment, of the first element adjustment and the second element adjustment, may be determined for use with users engaged in the activity and/or users associated with similar movement data.

In some implementations, the device may determine the adjustments using a model (e.g., a machine learning model), in a manner as described in connection with FIG. 2. The model may be trained to output the adjustments based on an input of the data relating to the movement of the device, information relating to the user interface to be provided for presentation by the device (e.g., the code that identifies the elements of the user interface), and/or information relating to the display capabilities of the device. The information relating to the user interface may indicate types of the elements of the user interface (e.g., a textual element, a form input element, or the like) and/or attributes of the elements of the user interface (e.g., a text size, an element color, or the like). The information relating to the display capabilities of the device may indicate a screen size of the device and/or a screen resolution of the device. In this way, the device may determine the adjustments directly from the data relating to the movement of the device (e.g., without determining the activity being performed by the user).

In some implementations, the device may transmit an indication of the activity being performed and/or the movement data to another device (e.g., a remote server) that implements the model or that communicates with the data structure. The device may receive an indication of the adjustments from the other device (e.g., based on a determination at the other device of the adjustments).

As shown in FIG. 1D, and by reference number 130, the device may cause presentation of the user interface with the elements adjusted. In particular, the elements may be adjusted in accordance with the adjustments that are determined. For example, the device may adjust the elements (e.g., adjust the code for the user interface) by changing a text size for an element, changing a text color of an element, changing a background color of an element, changing a size of an element, changing a shape of an element, changing a location of an element, removing an element, changing a formatting of an element, changing an interactable area for an element, changing a behavior of an element, and/or changing a layout of the user interface, among other examples.

In some implementations, to cause presentation of the user interface with the elements adjusted, the device may insert code into a document of the baseline user interface. For example, the device may insert code for the element adjustment that is selected from the data structure into the document. In some examples, the document may be an HTML, document, or the like, and the code that is inserted may be CSS code, JavaScript code, HTML code, or the like. Inserting the code may cause adjustment of one or more elements of the baseline user interface in accordance with the element adjustment. Based on inserting the code into the document, the device may provide the adjusted user interface for presentation by the device.

In some implementations, to cause presentation of the user interface with the elements adjusted, the device may modify the baseline user interface. For example, the device may modify code for the baseline user interface (e.g., modify a settings document linked with the user interface, modify a document that encodes the user interface, or the like) and/or the device may generate code (e.g., CSS code) that adjusts the baseline user interface (e.g., generate a settings document linked with the user interface).

In this way, the display of the user interface is adjusted based on the activity performed by the user and/or based on the movement data associated with the device. For example, if the user is running (e.g., the movement data is indicative of running), text elements can be adjusted to use larger text, input elements can be adjusted to use contrasting color, or the like. Accordingly, the adjusted user interface improves usability of the user interface and optimizes the user interface for the activity being performed by the user. This conserves computing resources and/or network resources that may otherwise be consumed when the user interacts with a user interface that is not optimized for the activity being performed by the user (e.g., due to inadvertent or incorrect requests made through the user interface by the user).

In some implementations, the device may monitor the user's interactions with the adjusted user interface. For example, the device may obtain data relating to an accuracy by which the user selects, clicks, taps, or the like, elements of the user interface, data relating to a behavior of the user when viewing the user interface (e.g., a scrolling behavior of the user, a zooming behavior of the user, a navigation behavior of the user, or the like), data relating to errors that are caused by the user's use of the user interface (e.g., form submission errors), or the like. Based on monitoring the user's interactions with the adjusted user interface, the device may determine one or more modifications to the adjustments of the user interface elements used for the user, for subsequent use with the user, or another user, when the activity is performed.

As indicated above, FIGS. 1A-1D are provided as an example. Other examples may differ from what is described with regard to FIGS. 1A-1D.

FIG. 2 is a diagram illustrating an example 200 of training and using a machine learning model in connection with movement-based adjustment of an element of a user interface. The machine learning model training and usage described herein may be performed using a machine learning system. The machine learning system may include or may be included in a computing device, a server, a cloud computing environment, or the like, such as the device (e.g., the user device) described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from one or more devices (e.g., one or more user devices), as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from one or more devices (e.g., one or more user devices). For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of an activity being performed, a second feature of a user interface element text size, a third feature of a user interface element text color, and so on. As shown, for a first observation, the first feature may have a value of “running,” the second feature may have a value of “9 pt”, the third feature may have a value of “gray,” and so on. These features and feature values are provided as examples, and may differ in other examples. For example, the feature set may include one or more of the following features: activity being performed, device movement data (e.g., accelerometer time series data, gyroscope time series data, and/or GNSS time series data, among other examples), element text size, element text color, element background color, element position, element type, element importance, device screen size, device screen resolution, or the like.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, or labels) and/or may represent a variable having a Boolean value. A target variable may be associated with a target variable value, and a target variable value may be specific to an observation. In example 200, the target variable is an adjustment for a user interface element, which has a value of “text size: 16 pt; text color: black” for the first observation. This adjustment indicates that the text size of the element is to be increased and the text color of the element is to be changed.

The feature set and target variable described above are provided as examples, and other examples may differ from what is described above. For example, for a target variable of an activity being performed, the feature set may include accelerometer time series data, gyroscope time series data, GNSS time series data, calendar data, audio data, video data, and/or biometric data.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of an activity being performed, a second feature of a user interface element text size, a third feature of a user interface element text color, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of “text size: 20 pt; text color: red” for the target variable of an adjustment for a user interface element for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples.

In some implementations, the recommendation and/or the automated action associated with the new observation may be based on a target variable value having a particular label (e.g., classification or categorization), may be based on whether a target variable value satisfies one or more thresholds (e.g., whether the target variable value is greater than a threshold, is less than a threshold, is equal to a threshold, falls within a range of threshold values, or the like), and/or may be based on a cluster in which the new observation is classified.

In this way, the machine learning system may apply a rigorous and automated process to adjust an element of a user interface. The machine learning system enables recognition and/or identification of tens, hundreds, thousands, or millions of features and/or feature values for tens, hundreds, thousands, or millions of observations, thereby increasing accuracy and consistency and reducing delay associated with activity identification and/or element adjustment relative to requiring computing resources to be allocated for tens, hundreds, or thousands of operators to manually identify an activity being performed by a user or determine an adjustment to a user interface element using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a user device 310, a server device 320, and a network 330. Devices of environment 300 may interconnect via wired connections, wireless connections, or a combination of wired and wireless connections.

The user device 310 includes one or more devices capable of receiving, generating, storing, processing, and/or providing information associated with adjustment of an element of a user interface, as described elsewhere herein. For example, the user device 310 may be capable of obtaining data associated with a movement of the user device 310, determining an activity being performed by a user of the user device 310 based on the data, determining an adjustment to an element of a user interface to be presented on the user device 310 based on the activity and/or the data, and/or adjusting the element of the user interface, as described elsewhere herein. The user device 310 may include a communication device and/or a computing device. For example, the user device 310 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The server device 320 includes one or more devices capable of receiving, generating, storing, processing, providing, and/or routing information associated with a user interface, as described elsewhere herein. For example, the server device 320 may provide information identifying the user interface for presentation on the user device 310. In some implementations, the server device 320 may implement a data structure that identifies element adjustments for user interface elements. The server device 320 may include a communication device and/or a computing device. For example, the server device 320 may include a server, such as an application server, a client server, a web server, a database server, a host server, a proxy server, a virtual server (e.g., executing on computing hardware), or a server in a cloud computing system. In some implementations, the server device 320 includes computing hardware used in a cloud computing environment.

The network 330 includes one or more wired and/or wireless networks. For example, the network 330 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 330 enables communication among the devices of environment 300.

The quantity and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to user device 310 and/or server device 320. In some implementations, user device 310 and/or server device 320 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The quantity and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

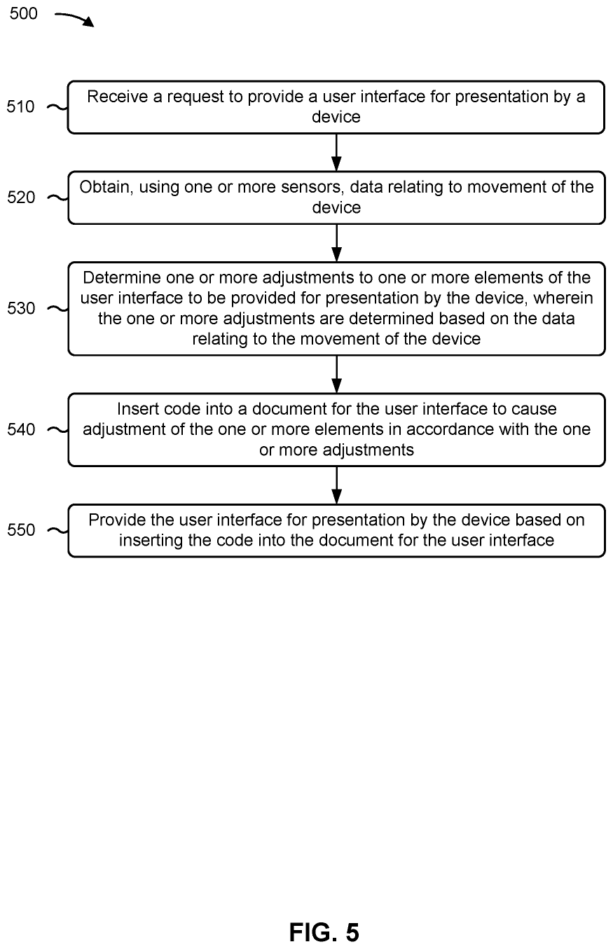

FIG. 5 is a flowchart of an example process 500 associated with movement-based adjustment of an element of a user interface. In some implementations, one or more process blocks of FIG. 5 may be performed by a device (e.g., user device 310). In some implementations, one or more process blocks of FIG. 5 may be performed by another device or a group of devices separate from or including the device, such as server device 320. Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include receiving a request to provide a user interface for presentation by a device (block 510). As further shown in FIG. 5, process 500 may include obtaining, using one or more sensors, data relating to movement of the device (block 520). As further shown in FIG. 5, process 500 may include determining one or more adjustments to one or more elements of the user interface to be provided for presentation by the device, wherein the one or more adjustments are determined based on the data relating to the movement of the device (block 530). As further shown in FIG. 5, process 500 may include inserting code into a document for the user interface to cause adjustment of the one or more elements in accordance with the one or more adjustments (block 540). As further shown in FIG. 5, process 500 may include providing the user interface for presentation by the device based on inserting the code into the document for the user interface (block 550).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A system for adjustment of a user interface to be provided for presentation by a device, the system comprising:
one or more memories; and
one or more processors, communicatively coupled to the one or more memories, configured to:
obtain data relating to movement of the device;
determine, based on the data relating to the movement of the device, an activity being performed by a user of the device;
select, from a data structure, one or more element adjustments for one or more elements of the user interface to be provided for presentation by the device,
wherein the one or more element adjustments are associated with adjusting a size of an interactable area or a behavior of the one or more elements based on determining the activity being performed by the user;
insert code into a document for the user interface to cause adjustment of the one or more elements according to the one or more element adjustments;
provide the user interface for presentation by the device based on inserting the code into the document for the user interface; and
monitor user interactions with the interactable area to obtain data associated with errors associated with the one or more elements.

2. The system of claim 1, wherein the one or more element adjustments are one or more first element adjustments if the activity being performed by the user is a first activity, and
wherein the one or more element adjustments are one or more second element adjustments if the activity being performed by the user is a second activity.

3. The system of claim 1, wherein the one or more element adjustments are based on historical data relating to interactions with adjusted elements by one or more other users performing the activity.

4. The system of claim 1, wherein the one or more elements include one or more textual elements, one or more form elements, or one or more user input elements of the user interface.

5. The system of claim 1, wherein the one or more element adjustments adjust at least one of a size, a shape, a color, a location, a formatting, the interactable area, or the behavior of the one or more elements.

6. The system of claim 1, wherein the data structure stores information relating to a plurality of element adjustments, and
wherein for each element adjustment, of the plurality of element adjustments, the information identifies a type of element that the element adjustment adjusts and an activity for which the element adjustment is used.

7. The system of claim 1, wherein the one or more elements are adjusted if the activity being performed by the user is a non-stationary activity.

8. The system of claim 1, wherein the data relating to the movement of the device is from at least one of an accelerometer of the device, a gyroscope of the device, or a global positioning system of the device.

9. A method of adjustment of a user interface to be provided for presentation by a device, comprising:
obtaining, by the device, using one or more sensors, data relating to movement of the device;
determining, by the device, one or more adjustments to one or more elements of the user interface to be provided for presentation by the device,
wherein the one or more adjustments are determined based on the data relating to the movement of the device, and
wherein the one or more adjustments are associated with adjusting a size of an interactable area or a behavior of the one or more elements;
causing, by the device, presentation of the user interface with the one or more elements adjusted in accordance with the one or more adjustments; and
monitoring user interactions with the interactable area to obtain data associated with errors associated with the one or more elements.

10. The method of claim 9, further comprising:
determining, based on the data relating to the movement of the device, an activity being performed by a user of the device.

11. The method of claim 9, wherein the one or more adjustments, that are determined for the one or more elements, are replacement code for the one or more elements.

12. The method of claim 9, wherein determining the one or more adjustments to the one or more elements comprises:
selecting, from a data structure, one or more element adjustments for the one or more elements.

13. The method of claim 9, wherein the one or more adjustments to the one or more elements are determined based on the data relating to the movement of the device and at least one of:
a type of the one or more elements, or
attributes of the one or more elements.

14. The method of claim 9, wherein the one or more adjustments are determined using a machine learning model that is trained to output the one or more adjustments based on an input of the data relating to the movement of the device and information relating to the user interface to be provided for presentation by the device.

15. The method of claim 9, wherein the one or more adjustments include adjustments to at least one of a size, a shape, a color, a location, a formatting, the interactable area, or the behavior of the one or more elements.

16. A non-transitory computer-readable medium storing a set of instructions for adjustment of a user interface to be provided for presentation by a device, the set of instructions comprising:
one or more instructions that, when executed by one or more processors of the device, cause the device to:
receive a request to provide the user interface for presentation by the device;
obtain, using one or more sensors, data relating to movement of the device;
determine, using a data structure, one or more adjustments to one or more elements of the user interface to be provided for presentation by the device,
wherein the one or more adjustments are determined based on the data relating to the movement of the device, and
wherein the one or more adjustments are associated with adjusting a size of an interactable area or a behavior of the one or more elements;
insert code into a document for the user interface to cause adjustment of the one or more elements in accordance with the one or more adjustments;
provide the user interface for presentation by the device based on inserting the code into the document for the user interface; and
monitor user interactions with the interactable area to obtain data associated with errors associated with the one or more elements.

17. The non-transitory computer-readable medium of claim 16, wherein the one or more instructions, when executed by the one or more processors, further cause the device to:
determine, based on the data relating to the movement of the device, an activity being performed by a user of the device.

18. The non-transitory computer-readable medium of claim 16, wherein the data structure stores information relating to a plurality of element adjustments, and
wherein for each element adjustment, of the plurality of element adjustments, the information identifies a type of element and an activity for which the element adjustment is used.

19. The non-transitory computer-readable medium of claim 18, wherein one or more of the plurality of element adjustments are based on historical data relating to interactions with adjusted elements by one or more other users performing the activity.

20. The non-transitory computer-readable medium of claim 16, wherein the one or more instructions, that cause the device to determine the one or more adjustments to the one or more elements, cause the device to:
select, from the data structure, one or more element adjustments for the one or more elements.
